(19) United States
(12) Patent Application Publication
(10) Pub. No.: US 2024/0243390 A1
(43) Pub. Date: Jul. 18, 2024

(54) ELECTRICALLY HEATED CATALYST SYSTEM

(71) Applicants: TOYOTA JIDOSHA KABUSHIKI KAISHA, Toyota-shi (JP); NGK INSULATORS, LTD., Nagoya-shi (JP)

(72) Inventors: Shinobu SHIMASAKI, Toyota-shi (JP); Takahiro SADAMITSU, Miyoshi-shi (JP); Tatsuo IIDA, Anjo-shi (JP); Katsumi SAIKI, Nagoya-shi (JP); Ryosuke SAKAI, Nagoya-shi (JP)

(73) Assignees: TOYOTA JIDOSHA KABUSHIKI KAISHA, Toyota-shi (JP); NGK INSULATORS, LTD., Nagoya-shi (JP)

(21) Appl. No.: 18/411,685

(22) Filed: Jan. 12, 2024

(30) Foreign Application Priority Data
Jan. 18, 2023 (JP) 2023-005820

(51) Int. Cl. H01M 12/06; H01M 4/38; H01M 4/48

(52) U.S. Cl. CPC H01M 12/06; H01M 4/38; H01M 4/48; H01M 2220/20

(57) ABSTRACT

An electrically heated catalyst system includes a catalyst support that is made of a conductive material and includes an outer surface, a pair of metal terminals attached to the outer surface of the catalyst support, a buck-boost converter that applies a voltage across the two metal terminals, an inverter that is disposed between the two metal terminals and the buck-boost converter and switches a direction of energization to the two metal terminals, and a controller that controls the inverter. When an energization time to the two metal terminals reaches the end of a prescribed time interval, the controller switches the direction of energization to the two metal terminals.

### BACKGROUND

### 1. Field

The present disclosure relates to an electrically heated catalyst system.

### 2. Description of Related Art

Japanese Laid-Open Patent Publication No. 2017-193244 discloses an internal combustion engine equipped with an electrically heated catalyst system. The catalyst system includes a direct-current power supply, a catalyst support, and a pair of electrodes. The catalyst support is made of a conductive material. The two electrodes are attached to the outer surface of the catalyst support. The two electrodes are connected to the direct-current power supply. When the two electrodes are energized, current flows through the catalyst support. The electrical resistance of the catalyst support causes the catalyst support to generate heat.

When energization is continued to the two electrodes, oxides may form on the negative electrode, depending on the type of metal material constituting the electrodes. When such oxides increase, the electrical resistance of the electrodes increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electrically heated catalyst system includes a catalyst support that is made of a conductive material and includes an outer surface, a pair of metal terminals attached to the outer surface of the catalyst support, a direct-current power supply configured to apply a voltage across the two metal terminals, a switching circuit that is disposed between the two metal terminals and the direct-current power supply and is configured to switch a direction of energization to the two metal terminals, and a controller configured to control the switching circuit. When an energization time to the two metal terminals reaches an end of a prescribed time interval, the controller switches the direction of energization to the two metal terminals.

In another general aspect, an electrically heated catalyst system includes a catalyst support that is made of a conductive material and includes an outer surface, a pair of metal terminals attached to the outer surface of the catalyst support, a direct-current power supply configured to apply a voltage across the two metal terminals, a switching circuit that is disposed between the two metal terminals and the direct-current power supply and is configured to switch a direction of energization to the two metal terminals, and a controller configured to control the switching circuit. A period from start to end of energization to the two metal terminals is referred to as an energization step. When the number of executions of the energization step reaches a prescribed count, the controller switches the direction of energization to the two metal terminals.

In a further general aspect, an electrically heated catalyst system includes a catalyst support that is made of a conductive material and includes an outer surface, a pair of metal terminals attached to the outer surface of the catalyst support, and a power supply configured to apply a voltage across the two metal terminals. The power supply is an alternating-current power supply.

In each of the above-described configurations, the direction of energization to the two metal terminals is switched. The inventor of the present application has found that the generation of metal oxide at the negative electrode is suppressed by switching the direction of energization to the two metal terminals. The suppression of generation of metal oxide limits increases in the electric resistance of the metal terminals.

Other features and aspects will be apparent from the following detailed description, the drawings, and the claims.

### BRIEF DESCRIPTION OF THE DRAWINGS

FIG. 1 is a schematic diagram showing a configuration of a vehicle.

FIG. 2 is a plan view of a catalyst device.

FIG. 3 is a diagram showing a configuration of an electrically heated catalyst system.

FIG. 4 is a flowchart showing a procedure of a temperature increasing process.

FIG. 5 is a diagram showing changes in an electrical resistance of a surface electrode layer.

FIG. 6 is a schematic diagram showing a switching circuit according to a modification.

FIG. 7 is a schematic diagram showing an electrically heated catalyst system according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An electrically heated catalyst system 100 according to one embodiment will now be described with reference to the drawings.

### Overall Configuration of Vehicle

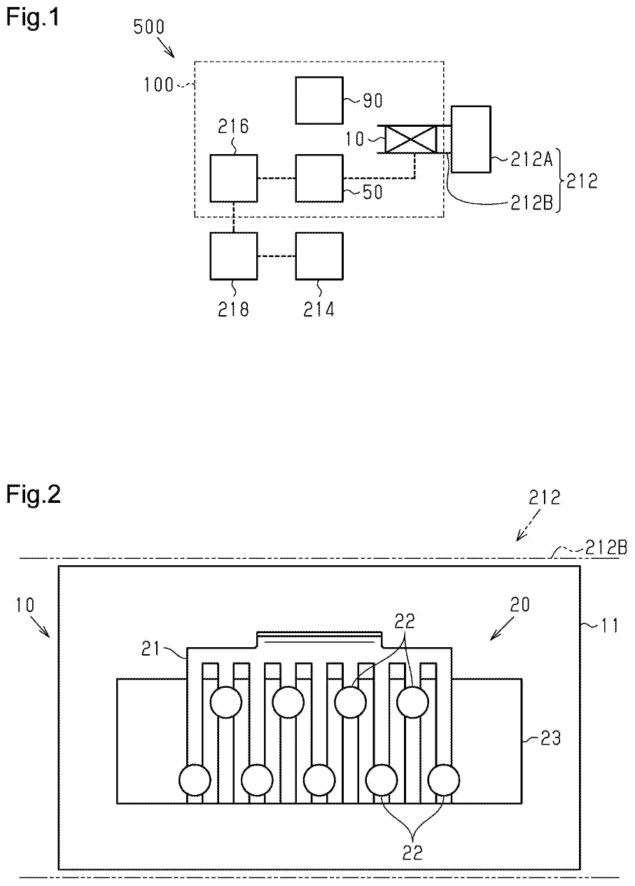

As shown in FIG. 1, a hybrid electric vehicle (hereinafter, referred to simply as the vehicle 500) includes an internal combustion engine 212, a motor-generator 214, a battery 216, and an inverter 218. The internal combustion engine 212 is a drive source of the vehicle 500. The internal combustion engine 212 includes an engine main body 212A and an exhaust passage 212B. In each cylinder of the engine main body 212A, an air-fuel mixture of intake air and fuel is burned. Exhaust gas discharged from the cylinders flows through the exhaust passage 212B. The motor-generator 214 is a drive source of the vehicle 500. The motor-generator 214 functions as both an electric motor and a generator. The motor-generator 214 is, for example, a three-phase alternating current motor-generator. The motor-generator 214 is coupled to the internal combustion engine 212. The battery 216 is a rechargeable battery that supplies power to the motor-generator 214 and stores power generated by the motor-generator 214. The inverter 218 converts alternating current to a direct current between the battery 216 and the motor-generator 214.

The vehicle 500 includes the electrically heated catalyst system 100. The electrically heated catalyst system 100 includes a catalyst device 10, a power supply circuit 50, a controller 90, and the battery 216. The electrically heated catalyst system 100 will now be described.

### Catalyst Device

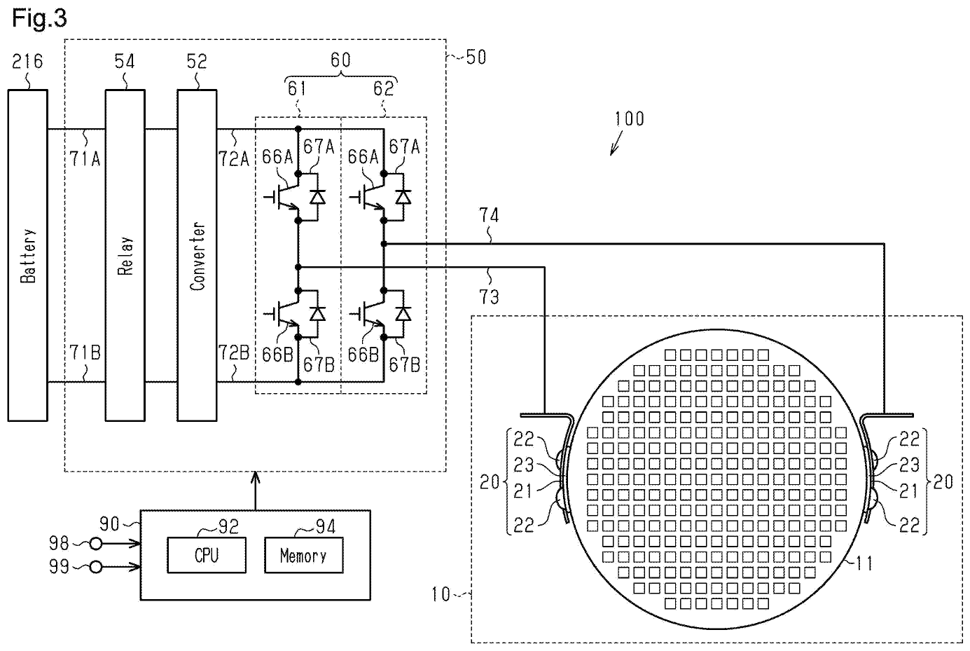

As shown in FIG. 2, the catalyst device 10 is arranged in the exhaust passage 212B of the internal combustion engine 212. The catalyst device 10 is inserted into a case (not shown). As shown in FIGS. 2 and 3, the catalyst device 10 includes a catalyst support 11 and a pair of metal terminals 20.

The catalyst support 11 has a columnar shape. The catalyst support 11 has a honeycomb structure with multiple fine pores. The fine pores extend through the catalyst support 11 in a direction in which the central axis of the catalyst support 11 extends. The wall surfaces of the fine pores support a three-way catalyst. The catalyst support 11 is made of a conductive material. The catalyst support 11 is a sintered body including, for example, a compound of silicon and silicon carbide as major components. The catalyst support 11 is also a conductor. When energized, the catalyst support 11 generates heat due to electrical resistance.

The two metal terminals 20 are respectively arranged at positions on the outer circumferential surface of the catalyst support 11 that are on opposite sides of the central axis of the catalyst support 11. The two metal terminals 20 are attached to the outer circumferential surface of the catalyst support 11. Each metal terminal 20 includes a surface electrode layer 23, a comblike electrode layer 21, and a fixing layer 22.

The surface electrode layer 23 is formed on the surface of the catalyst support 11. The surface electrode layer 23 is formed thermal spraying. The surface electrode layer 23 includes a metal matrix and oxide mineral particles dispersed in the metal matrix. The metal matrix includes chromium (Cr). A NiCr alloy is used as the metal matrix of the present embodiment. The oxide mineral particles include oxide such as silica and/or alumina as the major component. The oxide mineral particles also include bentonite and/or mica.

The comblike electrode layer 21 is a comb-shaped plate made of conductive metal such as an Fe—Cr alloy. The comblike electrode layer 21 is fixed to the surface of the surface electrode layer 23 by the fixing layer 22. The material of the fixing layer 22 is the same as that of the surface electrode layer 23.

### Power Supply Circuit

As shown in FIG. 3, the power supply circuit 50 is includes a DC/DC converter (hereinafter, referred to as the buck-boost converter 52), an inverter 60, and a relay 54.

The buck-boost converter 52 corresponds to a direct-current power supply. The buck-boost converter 52 includes transistors and/or diodes. The buck-boost converter 52 is connected to a positive terminal of the battery 216 via a first positive electrode line 71A. The buck-boost converter 52 is connected to a negative terminal of the battery 216 via a first negative electrode line 71B. The buck-boost converter 52 raises or lowers direct-current voltage input from the battery 216 and outputs the voltage to a second positive electrode line 72A and a second negative electrode line 72B.

The relay 54 is located in the middle of the first positive electrode line 71A and the first negative electrode line 71B. The relay 54 selectively establishes and breaks the electrical connection between the battery 216 and the buck-boost converter 52.

The inverter 60 is connected to the buck-boost converter 52 via the second positive electrode line 72A and the second negative electrode line 72B. The inverter 60 is also connected to the two metal terminals 20 via a third power line 73 and a fourth power line 74. That is, the inverter 60 is located between the buck-boost converter 52 and the two metal terminals 20. The inverter 60 converts the direct current from the buck-boost converter 52 into alternating current and outputs it to the two metal terminals 20. The inverter 60 corresponds to a switching circuit that switches the direction of energization to the two metal terminals 20.

The inverter 60 is configured, for example, as follows. The inverter 60 includes a first arm circuit 61 and a second arm circuit 62, which are connected in parallel. The first arm circuit 61 includes a first transistor 66A and a second transistor 66B, which are connected in series. The first transistor 66A and the second transistor 66B are both NPN transistors. The first arm circuit 61 includes a freewheeling first diode 67A and a freewheeling second diode 67B. The first diode 67A is connected in parallel to the first transistor 66A. The second diode 67B is connected in parallel to the second transistor 66B. The collector terminal of the first transistor 66A is connected to the second positive electrode line 72A. The emitter terminal of the second transistor 66B is connected to the second negative electrode line 72B. One of the two metal terminals 20 is referred to as a first metal terminal, and the other is referred to as a second metal terminal. The connecting point of the emitter terminal of the first transistor 66A and the collector terminal of the second transistor 66B is connected to the comblike electrode layer 21 of the first metal terminal via the third power line 73. The base terminal of the first transistor 66A and the base terminal of the second transistor 66B receive control voltage that selectively switches on and off the transistors from the controller 90, which will be discussed below.

The second arm circuit 62 includes two transistors 66A and 66B and two diodes 67A and 67B, like the first arm circuit 61. The second arm circuit 62 has the same structure as the first arm circuit 61 except for the following points. That is, in the second arm circuit 62, a connection point between the emitter terminal of the first transistor 66A and the collector terminal of the second transistor 66B is connected to the comblike electrode layer 21 of the second metal terminal via the fourth power line 74.

In the power supply circuit 50, when the relay 54 is on, the buck-boost converter 52 applies voltage across the two metal terminals 20. This energizes the catalyst support 11. The heat generated in response to the energization heats the catalyst support 11. Such electrical heating of the catalyst support 11 promotes a catalytic activity.

### Controller

The controller 90 may include one or more processors that perform various processes according to computer programs (software). The controller 90 may be circuitry including one or more dedicated hardware circuits such as application specific integrated circuits (ASICs) that execute at least part of various processes, or a combination thereof. The processor includes a CPU 92 and a memory 94 such as a RAM and a ROM. The memory 94 stores program codes or instructions configured to cause the CPU 92 to execute processes. The memory 94, which is a computer-readable medium, includes any type of media that are accessible by general-purpose computers and dedicated computers. The memory 94 includes a nonvolatile memory, which can be electrically rewritten. The controller 90 has a time measuring function.

The controller 90 receives detection signals from sensors 99 provided at various sections in the vehicle 500. FIG. 3 representatively shows one of the sensors 99. The detection signals include a traveling speed of the vehicle 500, the operation amount of the accelerator pedal of the vehicle 500, and a state of charge, which corresponds to the remaining capacity of the battery 216. The detection signals also include a rotational position of the output shaft of the internal combustion engine 212, an intake air amount of the internal combustion engine 212, and a temperature of coolant flowing through the engine main body 212A. Further, the detection signals include the current supplied to the catalyst device 10 and the voltage applied to the catalyst device 10. The controller 90 also receives a signal from a start switch 98 in the vehicle 500. The start switch 98 is used by an occupant to instruct activation of the vehicle 500 and is turned on or off in response to operation by the occupant.

The controller 90 controls the power supply circuit 50. That is, the controller 90 controls the buck-boost converter 52 and the inverter 60. The controller 90 controls the power supply circuit 50 to energize the catalyst device 10. The controller 90 regulates the frequency of the alternating current flowing through the two metal terminals 20 by turning on and off the transistors of the inverter 60.

The controller 90 stores, in a nonvolatile memory, an energization accumulated value KA, which is an accumulated value of energization time of the two metal terminals 20. The energization accumulated value KA is set to zero at the time of factory shipment of the vehicle 500. In the present embodiment, the time of factory shipment of the vehicle 500 is treated as the time of the new condition of the catalyst device 10. After energizing the two metal terminals 20 after the time of the new condition, the controller 90 updates the energization accumulated value KA as needed.

In addition to the power supply circuit 50, the controller 90 also controls other vehicle mounted components such as the internal combustion engine 212 and the motor-generator 214. For example, the controller 90 controls ignition plugs and fuel injection valves, which are attached to the engine main body 212A of the internal combustion engine 212, thereby burning air-fuel mixture in the engine main body 212A. While the start switch 98 is on, the controller 90 starts the internal combustion engine 212 or changes the load state of the internal combustion engine 212 based on a required torque of the internal combustion engine 212, which is obtained from the traveling speed of the vehicle 500, the operation amount of the accelerator pedal, and the like.

The controller 90 uses, for example, the driving force of the internal combustion engine 212 to cause the motor-generator 214 to generate power when necessary. In the internal combustion engine 212, the catalyst supported by the catalyst support 11 purifies hazardous constituents in exhaust gas. Immediately after the internal combustion engine 212 is started, the temperature of the catalyst support 11 is low. The catalyst is thus inactive.

During a no-load operation or a low-load operation of the internal combustion engine 212, the temperature of exhaust gas flowing through the exhaust passage 212B is relatively low. If this state continues, the temperature of the catalyst support 11 is lowered, so that the catalyst may become inactive. In this regard, the controller 90 executes a temperature increasing process as a process that heats the catalyst support 11 immediately after the internal combustion engine 212 is started and during a no-load operation or a low-load operation of the internal combustion engine 212. The controller 90 executes the temperature increasing process to energize the catalyst device 10 over a predetermined specified time interval L. The specified time interval L is, for example, one minute. The controller 90 stores the specified time interval L in advance.

During energization, the controller 90 switches the direction of energization to the two metal terminals 20 when the energization time to the two metal terminals 20 reaches the end of a prescribed time interval K. The controller 90 may switch the energization direction at the point when the energization time reaches the prescribed time interval K. Alternatively, the controller 90 may swiftly switch the energization direction after the energization time reaches the end of the prescribed time interval K. The controller 90 will repeatedly switch the energization direction during energization, based on the specified time K, following either of these standard rules. The controller 90 changes the prescribed time interval K, which is used to switch the energization direction, in accordance with the energization accumulated value KA. Specifically, the controller 90 sets the prescribed time interval K to be longer when the energization accumulated value KA is increased to be greater than or equal to a change threshold N than when the energization accumulated value KA is less than the change threshold N. That is, the controller 90 sets the prescribed time interval K to be longer when the energization accumulated value KA is greater than or equal to the change threshold N than when the energization accumulated value KA is less than the change threshold N.

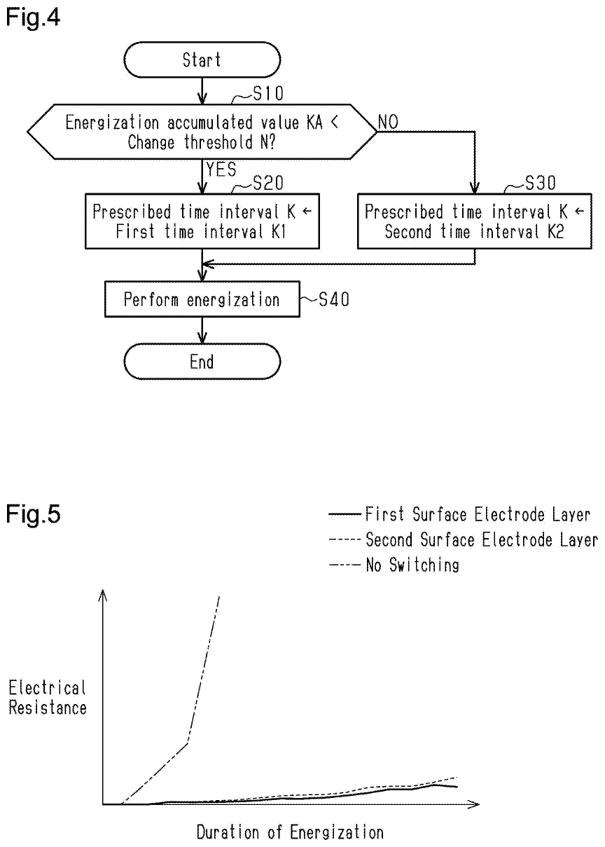

As shown in FIG. 4, when starting the temperature increasing process, the controller 90 first executes the process of step S10. In step S10, the controller 90 determines whether the energization accumulated value KA stored in the nonvolatile memory at the point in time when step S10 is executed is less than the change threshold N. The controller 90 stores the change threshold N in advance. The change threshold N is longer than the specified time interval L. For example, the change threshold N is a value obtained by multiplying the specified time interval L by an integer. The change threshold N will be described in detail later. When determining that the energization accumulated value KA is less than the change threshold N (step S10: YES), the controller 90 advances the process to step S20. In this case, in step S20, the controller 90 sets the prescribed time interval K for controlling the inverter 60 to a first time interval K1. The controller 90 stores the first time interval K1 in advance. The first time interval K1 is shorter than the specified time interval L. The first time interval K1 is, for example, 0.01 seconds. The first time interval K1 will be described in detail later. After executing the process of step S20, the controller 90 advances the process to step S40.

When the energization accumulated value KA is greater than or equal to the change threshold N (step S10: NO), the controller 90 advances the process to step S30. In this case, in step S30, the controller 90 sets the prescribed time interval K for controlling the inverter 60 to a second time interval K2. The controller 90 stores the second time interval K2 in advance. The second time interval K2 is longer than the first time interval K1 and shorter than the specified time interval L. The second time interval K2 will be described in detail later.

In step S40, the controller 90 energizes the catalyst device 10 for the specified time interval L. During the energization, the controller 90 causes the buck-boost converter 52 to output a predetermined constant set voltage. The controller 90 controls the inverter 60 such that the direction of energization to the two metal terminals 20 is switched every prescribed time interval K. In other words, the controller 90 controls the switching of each transistor such that twice the prescribed time interval K is one cycle of alternating current. When starting energization, the controller 90 switches the relay 54 from off to on. When ending energization, the controller 90 switches the relay 54 from on to off. Upon completion of energization for the specified time interval L, the controller 90 ends the series of processes of the temperature increasing process. After ending the temperature increasing process, the controller 90 updates the energization accumulated value KA stored in the nonvolatile memory. Specifically, the controller 90 calculates, as the latest value, a value obtained by adding the specified time interval L to the energization accumulated value KA stored at the point in time the temperature increasing process ends. The controller 90 stores the latest value as a new energization accumulated value KA in the nonvolatile memory. The controller 90 sequentially executes the above-described temperature increasing process in accordance with the operating state of the internal combustion engine 212. In other words, the controller 90 executes the temperature increasing process every time an opportunity arises, such as at the start of the internal combustion engine 212, during no-load operation, and during low-load operation. Consequently, the accumulated energization value KA progressively increases during a single trip, and furthermore, it continues to increase incrementally as the number of trips increases. A single trip is a period from when the start switch 98 is turned on to when the start switch 98 is turned off.

### Increase in Electrical Resistance of Surface Electrode Layer

In the following, the reason for switching the direction of energization to the two metal terminals 20 as an operation of the present embodiment will be described. First, an increase in the electrical resistance of the surface electrode layer 23 will be described.

The surface electrode layer 23 has many small voids when it is new. When the two metal terminals 20 are energized, electrons are transferred through the surface electrode layer 23, which is a negative electrode. When the duration of the energization increases, the movement of electrons becomes active in the negative-side surface electrode layer 23. Accordingly, in the negative-side surface electrode layer 23, electrons repeatedly and continuously collide with Cr atoms. Such collisions of electrons move Cr atoms. Movements of these Cr atoms cause voids existing in the negative-side surface electrode layer 23 to expand or merge. This increases the sizes of the voids. As the sizes of the voids increase, more oxygen enters the voids. This promotes oxidation of Cr atoms inside the voids. Accordingly, columnar Cr oxides (hereinafter referred to as columnar oxides) form inside the voids. When columnar oxides form, the conduction region in the surface electrode layer 23 is reduced, so that the electrical resistance of the negative-side surface electrode layer 23 increases.

Once columnar oxides start to formed, the following problem occurs. As the voids expand, many columnar oxides grow at an accelerated rate. Thus, if the energization is continued without switching the direction of energization to the two metal terminals 20, the electrical resistance rapidly increases in the negative-side surface electrode layer 23 as indicated by the long-dash double-short-dash line in FIG. 5. The negative-side surface electrode layer 23 thus has an excessively high electrical resistance. This increases the potential difference between the negative-side surface electrode layer 23 and the comblike electrode layer 21 that is in contact with the negative-side surface electrode layer 23. As a result, the negative-side surface electrode layer 23 and the comblike electrode layer 21 generate excessive heat, so that the surface electrode layer 23 and the comblike electrode layer 21 are disconnected from each other due to melting.

### Switching of Energization Direction and Suppression of Increase in Electrical Resistance

To prevent disconnection due to melting between the surface electrode layer 23 and the comblike electrode layer 21, the controller 90 in the above-described configuration repeatedly switches the direction of energization to the two metal terminals 20. It is experimentally known that this switching has the effect of suppressing the increase in electrical resistance of the surface electrode layer 23. Below, two speculated mechanisms for suppressing the increase in electrical resistance of the surface electrode layer 23 will be listed as items (A) and (B).

(A) As described above, movements of Cr atoms in the negative-side surface electrode layer 23 are thought to be caused by continuous collisions with electrons when energization continues for an extended period. In contrast, if the period of energization is relatively short, Cr atoms are not likely to move since the number of collisions of electrons with the Cr atom is relatively small. In this regard, in the above-described configuration, the controller 90 switches the direction of energization to the two metal terminals 20 at short time intervals. In this case, the positive electrode and the negative electrode of the two metal terminals 20 are switched before movements of Cr atoms and the consequent expansion of voids occur in the negative-side surface electrode layer 23. Since the positive electrode and the negative electrode of the two metal terminals 20 are switched repeatedly before the voids expand, the voids remain small in the surface electrode layers 23 of both metal terminals 20. This suppresses the increase in electrical resistance of the surface electrode layers 23 of both metal terminals 20.

(B) As a precondition, a passivation film, which is an oxide film of Cr formed on the surface electrode layer 23, will be described. When the two metal terminals 20 are energized, the following occurs in both the metal terminal 20 that serves as a positive electrode and the metal terminal 20 that serves as a negative electrode. That is, the above-described passivation film is formed in each surface electrode layer 23 separately from columnar oxides. The passivation film is formed on the outer circumferential surface and/or cracks of the surface electrode layer 23. The columnar oxides do not grow unless the voids become larger. This is because if the voids do not become larger, a sufficient amount of oxygen for oxidation cannot be taken into the voids. For the voids to become larger, a correspondingly long duration of energization is necessary. For this reason, columnar oxides are not easily formed until the duration of energization to the surface electrode layer 23 increases to a certain extent.

The above-described passivation film, formed on the outer circumferential surface of the surface electrode layer 23 and the like, is formed as the outer circumferential surface of the surface electrode layer 23 comes into contact with abundant outside air. The passivation film is thus formed at an early stage of the energization to the surface electrode layer 23. The formation of the passivation film on the surface electrode layer 23 is limited to the outer circumferential surface and cracks. Thus, the amount of the passivation film formed is relatively small. Thus, the electrical resistance of the surface electrode layer 23 is not excessively increased due to the formation of the passivation film.

The passivation film is materially very stable. Thus, if there is a passivation film on the negative-side surface electrode layer 23, movements of Cr atoms caused by collisions with electrons are hindered in parts surrounding a region of the surface electrode layer 23 in which the passivation film is formed. Accordingly, the voids are unlikely to expand around the passivation film. That is, in the negative-side surface electrode layer 23, the passivation film suppresses the increase in size of the voids and thus suppresses the generation of columnar oxides. In this regard, if the direction of energization to the metal terminals 20 is repeatedly switched, the generation of columnar oxides is suppressed as described below.

A case will be described in which the two new metal terminals 20 are energized, and the direction of energization to the metal terminals 20 is switched at short time intervals. As described above, after starting the energization, passivation film is formed on the surface electrode layer 23 of both of the two metal terminals 20 from the initial stage of the energization. Due to the short energization time in the same energization direction, a passive film is formed in the surface electrode layer 23 that is the negative electrode at that point in time of the two metal terminals 20, while the expansion of voids or the formation of columnar oxides do not occur. For this reason, if the energization time is shortened when switching the energization direction, only the passivation film is mainly formed on the surface electrode layers 23 of the two metal terminals 20. As a result, if the passivation film of the surface electrode layer 23 of each of the two metal terminals 20 is formed to be wide, the formation of voids and consequently the formation of columnar oxides in the surface electrode layer 23 of each of the two metal terminals 20 are suppressed.

The following is achieved for the reasons described in items (A) and (B) described above. The surface electrode layer 23 of one of the two metal terminals 20 is referred to as a first surface electrode layer, and the surface electrode layer 23 of the other is referred to as a second surface electrode layer. When the direction of energization to the two metal terminals 20 is switched at short time intervals, the electrical resistances of the first surface electrode layer and the second surface electrode layer scarcely increase even if the duration of the energization increases as shown in FIG. 5. In FIG. 5, changes in the electrical resistance of the first surface electrode layer are represented by the solid line. In FIG. 5, changes in the electrical resistance of the second surface electrode layer are represented by the broken line.

### First Time Interval, Second Time Interval, and Change Threshold

The first time interval K1 and the second time interval K2, which are set to the prescribed time interval K, and the change threshold N are set in association with each other based on the above-described items (A) and (B). The first time interval K1 is predetermined, for example through experiments or simulations, as a value that suppresses the increase in electrical resistance of the surface electrode layers 23 when the two metal terminals 20 are energized while the metal terminals 20 are new.

The first time interval K1 is a period during which the voids do not expand in the surface electrode layers 23 even if only a small amount of passivation film is formed on the surface electrode layers 23. The second time interval K2 is predetermined, for example through experiments or simulations, as a value that suppresses the increase in electrical resistance of the surface electrode layers 23 after the two metal terminals 20 have been energized for a certain period of time. The second time interval K2 is a period during which the voids do not expand in the surface electrode layers 23 if a large amount of passivation film is formed on the surface electrode layers 23.

The change threshold N is set, for example, through experiments or simulations to such a value that the electrical resistances of the surface electrode layers 23 do not increase even if the prescribed time interval K is switched from the first time interval K1 to the second time interval K2. The change threshold N is an accumulated value of the energization time required to form a large amount of passivation film to such an extent that voids are unlikely to expand in the surface electrode layers 23.

### Advantages of Embodiment

(1) As described above, the controller 90 uses the inverter 60 in the temperature increasing process to switch the direction of energization to the two metal terminals 20. This suppresses increases in the electrical resistances of the surface electrode layers 23 of the two metal terminals 20.

(2) As described in item (B) above, a passivation film suppresses generation of columnar oxides. Once a passivation film is formed in a wide range, voids are unlikely to expand thereafter in the negative-side surface electrode layer 23. This allows the prescribed time interval K, which is the energization time in the same direction, to be extended. In this regard, in the above-described configuration, the prescribed time interval K is set to be short when the energization accumulated value KA remains below the change threshold N. Accordingly, the size of voids in the surface electrode layer 23 of each of the two metal terminals 20 is unlikely to be increased. After the energization accumulated value KA reaches the change threshold N, the prescribed time interval K is set to be relatively long. This reduces the complexity of the process for switching the direction of energization direction.

### Modifications

The above-described embodiment may be modified as follows. The above-described embodiment and the following modifications can be combined as long as the combined modifications remain technically consistent with each other.

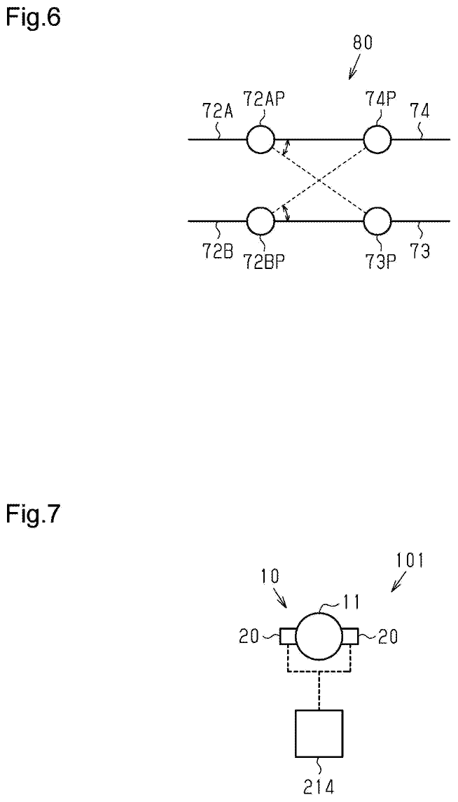

The configuration of the switching circuit is not limited to the example of the above-described embodiment. The switching circuit may have any configuration as long as the switching circuit is located between the two metal terminals 20 and the direct-current power supply and is capable of switching the direction of energization to the two metal terminals 20. For example, the inverter 60 may be replaced with a four-way switch 80 as shown in FIG. 6. The four-way switch 80 switches between a first state and a second state. As indicated by the solid lines in FIG. 6, the first state is a state in which a contact point 72AP of the second positive electrode line 72A is connected to a contact point 74P of the fourth power line 74, and a contact point 72BP of the second negative electrode line 72B is connected to a contact point 73P of the third power line 73. As indicated by the dotted lines in FIG. 6, the second state is a state in which the contact point 72AP of the second positive electrode line 72A is connected to a contact point 73P of the third power line 73, and the contact point 72BP of the second negative electrode line 72B is connected to the contact point 74P of the fourth power line 74. The controller 90 may control the four-way switch 80 using command signals. The controller 90 may switch the four-way switch 80 between the first state and the second state, so as to switch the direction of energization to the two metal terminals 20 at the prescribed time interval K.

The above-described specified time interval L, which is the total time for energization in a single execution of the temperature increasing process, may be changed in accordance with the state of the internal combustion engine 212 when the temperature increasing process is executed. For example, the specified time interval L may be changed in accordance with the temperature of the catalyst support 11 at the time of starting the temperature increasing process. The temperature of the catalyst support 11 can be estimated based on, for example, the temperature of coolant in the engine main body 212A.

The point in time at which energization ends in a single execution of the temperature increasing process does not necessarily need to be determined based on time, which is the specified time interval L, but may be determined using other criteria. For example, a target amount of power that should be supplied in a single execution of the temperature increasing process may be determined. In this case, the end time of energization is determined based on the fact that the supply of the target amount of power has been completed.

The output voltage of the buck-boost converter 52 may be changed depending on the state of the internal combustion engine 212 each time the temperature increasing process is executed. For example, the lower the temperature of the catalyst support 11 at the start of the temperature increasing process, the higher the output voltage may be set. The output voltage may be maintained in a single execution of the temperature increasing process.

The higher the output voltage of the buck-boost converter 52, the more active the movement of electrons can become in the negative-side surface electrode layer 23. Accordingly, the movement of Cr atoms and consequently the expansion of voids are likely to occur in the negative-side surface electrode layer 23. In this regard, the prescribed time interval K, which is related to the switching of the direction of energization to the two metal terminals 20 in the temperature increasing process, may be set as follows. Specifically, when the energization accumulated value KA is less than the change threshold N, the prescribed time interval K is set to be shorter as the output voltage from the buck-boost converter 52 increases. The upper limit of the prescribed time interval K is set to be less than the second time interval K2. When the energization accumulated value KA increases to be greater than or equal to the change threshold N, that is, when expansion of the voids is unlikely to occur in the negative-side surface electrode layer 23, the prescribed time interval K is set to the second time interval K2 as in the above-described embodiment.

If such settings are adopted, under circumstances where the energization accumulated value KA is less than the change threshold N, the time of energization in the same direction will be shorter when the output voltage from the buck-boost converter 52 is relatively high than when it is relatively low. Accordingly, the increase in the electrical resistance at the negative-side surface electrode layer 23 is suppressed regardless of the magnitude of the output voltage from the buck-boost converter 52.

In the above-described modification, which changes the prescribed time interval K in accordance with the output voltage of the buck-boost converter 52, the prescribed time interval K does not necessarily have to be reduced as the output voltage of the buck-boost converter 52 increases. For example, the prescribed time interval K may have several stages for the output voltage. This configuration is suitable for suppressing the increase in electrical resistance of the negative-side surface electrode layer 23 in accordance with the magnitude of the output voltage, as long as the following relationship is satisfied. The relationship is that the prescribed time interval K is shorter when the output voltage of the buck-boost converter 52 is a first value than when the output voltage of the buck-boost converter 52 is a second value, which is less than the first value.

The output voltage of the buck-boost converter 52 may be changed in a single execution of the temperature increasing process. Accordingly, the prescribed time interval K may be changed as in the above-described modification.

The change threshold N is not limited to an integral multiple of the specified time interval L, which is described in the above-described embodiment. The change threshold N may be set in accordance with the first time interval K1 and the second time interval K2. The first time interval K1 and the like are not limited to the values illustrated in the above-described embodiment.

The energization accumulated value KA may be updated sequentially during the execution of the temperature increasing process. Then, the specified time interval K may be changed at a point in time when the energization accumulated value KA reaches the change threshold N in the middle of a single execution of the temperature increasing process. In this manner, the prescribed time K may be longer when the energization accumulated value KA is greater than or equal to the change threshold N than when the energization accumulated value KA is less than the change threshold N.

The prescribed time interval K does not necessarily need to be changed through the change threshold N. That is, the prescribed time interval K does not need to be changed using the change threshold N, but may be used unchanged.

The handling of the catalyst device 10 when it is new is not limited to the example of the above-described embodiment. That is, the reference point in time for the energization accumulated value KA is not limited to that described in the above-described embodiment. The change threshold N simply needs to be set in accordance with the reference point in time of the energization accumulated value KA.

The relative magnitudes of the prescribed time interval K and the above-described specified time interval L are not limited to the examples of the above-described embodiment. For example, the first time interval K1 may be longer than the specified time interval L. In other words, the first time interval K1 may be longer than the total time of energizing the two metal terminals 20 in a single execution of the temperature increasing process. In this case, it is only necessary to appropriately control the switching circuit while measuring the time of energization to the two metal terminals 20 over multiple executions of the temperature increasing process. In an example, the first time interval K1 is set to 1.5 times the specified time interval L. In this case, in two different executions of the temperature increasing process, the energization direction is not switched during the first execution of the temperature increasing process, and the energization direction is switched during the subsequent execution of the temperature increasing process. As long as the electrical resistance of the surface electrode layer 23 is not increased, the first time interval K1 may be longer than the time for a single execution of the temperature increasing process once. The same applies to the second time interval K2. That is, the prescribed time interval K may be determined to avoid an increase in the electrical resistance of the surface electrode layer 23. Also, any configuration may be employed as long as the energization direction is switched when the time of energization to the two metal terminals 20 reaches the end of the prescribed time interval K.

The direction of energization to the two metal terminals 20 may be switched with reference to the number of executions of the temperature increasing process. That is, a period from the start to the end of energization to the two metal terminals 20 is referred to as an energization step. When the number of executions of the energization step reaches a prescribed count, that is, when the prescribed number of executions of the energization step have been executed, the controller 90 switches the direction of energization to the two metal terminals 20. The prescribed count may be set to any value that prevents the increase in the electrical resistance of the surface electrode layer 23. In this manner, the energization direction may be switched using, as a criterion, a number of times instead of time intervals. The energization step corresponds to the process of step S40 in the temperature increasing process. The controller 90 only needs to store the prescribed count in advance. The controller 90 may consecutively increment the number of executions of the energization step. When the number of executions reaches the prescribed count, the count is reset to zero.

In the above-described modification of switching the direction of energization based on the number of executions of the temperature increasing process, the direction of energization to the two metal terminals 20 remains the same in a single execution of the temperature increasing process. In this case, direct current is supplied to the two metal terminals 20. The same situation may occur if the prescribed time interval K is set to be longer than or equal to the specified time interval L. Thus, the current supplied to the two metal terminals 20 is not limited to alternating current, but may be direct current.

The situation in which the temperature increasing process is executed is not limited to the example in the above-described embodiment. For example, the temperature increasing process may be executed before the internal combustion engine 212 is started. The temperature increasing process simply needs to be executed in a situation in which the catalyst support 11 needs to be heated.

The configuration of the catalyst support 11 is not limited to the example in the above-described embodiment. The catalyst support 11 is made of any suitable material as long as it is conductive.

The catalyst supported by the catalyst support 11 is not limited to the example in the above-described embodiment. For example, the catalyst may be an oxidation catalyst, a storage-reduction NOx catalyst, or a selective reduction NOx catalyst.

The metal matrix is not limited to the example in the above-described embodiment. For example, a MCrAlY alloy may be used as the metal matrix. The letter M represents at least one of Fe, Co, and Ni.

The configuration of the metal terminals 20 maybe changed from the example of the above-described embodiment as long as it is possible to suppress the increase in electrical resistance of the surface electrode layers 23 by switching the direction of energization to the two metal terminals 20.

The overall configuration of the vehicle 500 is not limited to the example in the above-described embodiments. For example, the vehicle 500 may have a plug-in feature that allows the battery 216 to be connected to and charged by a power source outside the vehicle 500. The vehicle 500 may include multiple motor-generators 214. The vehicle 500 may have only the internal combustion engine 212 as its drive source, and does not necessarily have to include the motor-generator 214.

The direct-current power supply is not limited to the example in the above-described embodiment. Any type of direct-current power supply may be employed as long as it can apply voltage across the two metal terminals 20. For example, the direct-current power supply may be an AC/DC converter that converts alternating-current voltage into direct-current voltage and outputs the direct-current voltage. As in the above-described modifications related to the overall configuration of the vehicle 500, in the case of a vehicle 500 having a plug-in feature, alternating-current voltage from a power supply outside the vehicle 500 may be converted into direct-current voltage by an AC/DC converter and output to a switching circuit.

The controller 90, which controls the power supply circuit 50, and a controller that controls other vehicle on-board components may be provided separately. In this case, the controllers may have any configuration if they can transfer information to and from each other.

As an electrically heated catalyst system 101, the configuration shown in FIG. 7 may be employed. In the electrically heated catalyst system 101 shown in FIG. 7, the configuration of the above-described embodiment that connects the power supply circuit 50 and the catalyst device 10 to each other is replaced by a configuration that connects a motor-generator 214 and the catalyst device 10 mounted on the vehicle 500 to each other. The alternate current generated by the motor-generator 214 is supplied to the two metal terminals 20 without being changed. That is, the electrically heated catalyst system 101 includes the catalyst support 11, two metal terminals 20 attached to the outer surface of the catalyst support 11, and the motor-generator 214 serving as an alternating-current power source. Switching on and off the energization to the two metal terminals 20 can be suitably carried out using relays or the like. In FIG. 7, the same symbols are assigned to parts that are identical or substantially identical in function to those in the above-described embodiment.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electrically heated catalyst system, comprising:
a catalyst support that is made of a conductive material and includes an outer surface;
a pair of metal terminals attached to the outer surface of the catalyst support;
a direct-current power supply configured to apply a voltage across the two metal terminals;
a switching circuit that is disposed between the two metal terminals and the direct-current power supply and is configured to switch a direction of energization to the two metal terminals; and
a controller configured to control the switching circuit,
wherein, when an energization time to the two metal terminals reaches an end of a prescribed time interval, the controller switches the direction of energization to the two metal terminals.

2. The electrically heated catalyst system according to claim 1, wherein, if an accumulated value of the energization time to the two metal terminals is greater than or equal to a predetermined change threshold, the controller sets the prescribed time interval to be longer than that in a case in which the accumulated value is less than the change threshold.

3. The electrically heated catalyst system according to claim 1, wherein
the direct-current power supply includes a DC/DC converter that raises or lowers an input direct-current voltage and outputs the voltage to the switching circuit, and
the controller sets the prescribed time interval to be shorter when an output voltage of the DC/DC converter is a first value than when the output voltage of the DC/DC converter is a second value, the second value being less than the first value.

4. An electrically heated catalyst system, comprising:
a catalyst support that is made of a conductive material and includes an outer surface;
a pair of metal terminals attached to the outer surface of the catalyst support;
a direct-current power supply configured to apply a voltage across the two metal terminals;
a switching circuit that is disposed between the two metal terminals and the direct-current power supply and is configured to switch a direction of energization to the two metal terminals; and
a controller configured to control the switching circuit, wherein
a period from start to end of energization to the two metal terminals is referred to as an energization step, and
when the number of executions of the energization step reaches a prescribed count, the controller switches the direction of energization to the two metal terminals.

5. An electrically heated catalyst system, comprising:
a catalyst support that is made of a conductive material and includes an outer surface;
a pair of metal terminals attached to the outer surface of the catalyst support; and
a power supply configured to apply a voltage across the two metal terminals,
wherein the power supply is an alternating-current power supply.
